(19) United States
(12) Patent Application Publication
(10) Pub. No.: US 2003/0014384 A1
(43) Pub. Date: Jan. 16, 2003

(54) Document exchange system

(76) Inventors: Alan Ewald, Ashby, MA (US); Owen Tallman, Lunenburg, MA (US); Tom Cooper, Sutton, MA (US); Peter J. Weyman, Uxbridge, MA (US)

Correspondence Address: IANDIORIO & TESKA, 260 BEAR HILL ROAD, WALTHAM, MA, 02451-1018, US

(21) Appl. No.: 09/790,824

(22) Filed: Feb. 22, 2001

(51) Int. Cl. G06F 7/00

(52) U.S. Cl. 707/1

(57) ABSTRACT

A document exchange system including a write dispatcher which receives semi-structured documents and access control information from a first party relating to authorized viewers of the document. A capsule creator merges the semi-structured document and the access control information from the write dispatcher into a second semi-structured document to form a capsule. A capsule database then stores the capsules. An indexer creates an index entry for the capsule and an index database stores these index entries. A read dispatcher receives inquiries and identification information from a second party. A query processor then searches the index database and a storage server retrieves all relevant capsules that the second party is authorized to access. A capsule extractor then extracts the posted documents to be forwarded to the second party.

### FIELD OF THE INVENTION

This invention relates to a document exchange system.

### BACKGROUND OF THE INVENTION

To avoid the need to interface directly with many different suppliers, documents such as requests for bids or quotes are now typically posted on a website accessible by various suppliers who then submit a bid or a quote in response to a company's request for quotes and/or the company's engineering or other specifications.

In one example, a motor vehicle manufacturer posts on its website a specification for car batteries, and various battery suppliers or manufacturers then each access the motor vehicle manufacturer's website and submit separate quotes. The motor vehicle manufacturer then receives the quotes and issues a purchase order to one battery supplier.

In another example, a manufacturer of consumer goods posts on its website a shipment request and different carriers reply with various quotes. Again, the supplier issues a purchase order to one carrier. In still another example, an insurance salesman posts a request for a quote for insurance coverage for a specific individual, and various insurance companies respond with quotes and coverage information. The above transactions typically take place on the Internet via the requesting party's website.

To date, each such website is typically custom in design. Therefore, the system designed for the motor vehicle manufacturer in the example above will not work for the insurance salesman. Present systems are also costly. In one example, an “electronic document exchange system” costs between $100,000 and $1,000,000. Worse, some entities who wish to submit quotes are often not very computer literate and thus have a difficult time working with different manufacturers' websites. In some cases, the specifications delineating how suppliers are required to submit bids are contained in a set of complex volumes.

The current hardware and software used in conjunction with such document programs are also fairly complex, especially when limits are placed on who has access to a given company's document exchange program.

For example, the automobile manufacturer discussed above may not want competitors to be able to access its battery specifications and may further limit access to pre-approved, pre-qualified vendors. In such a situation, an access control list is generated and only those suppliers whose names appear in the access control information are able to submit bids.

Currently, the document, i.e., the battery specification, is stored in a document storage database, the access control information is stored in a separate database, and a search engine in conjunction with a query processor receives all incoming search requests from suppliers. If the supplier is searching for battery specifications in order to submit a quote for batteries, the query processor assembles the search request from the supplier into a query, notes the supplier's identity, and passes the query to a search engine which searches the document database for documents which contain the word “battery.” Once all such documents are found, the query processor determines which found documents can be accessed by the supplier by searching the access control database and passing on to the supplier only those documents which the supplier is entitled to view.

Such an architecture is complex and actually results in two searches. Moreover, when a text based search engine such as ALTAVISTA® is used, it searches every word of the document and would find both relevant but also many irrelevant documents which include the word “battery”.

### SUMMARY OF THE INVENTION

It is therefore an object of this invention to provide a more efficient document exchange system.

It is a further object of this invention to provide such a document exchange system which is less costly than present systems.

It is a further object of this invention to provide such a document exchange system which is easier to use than the prior art document exchange systems.

It is a further object of this invention to provide such a document exchange system which is easier to implement than the prior art document exchange systems.

It is a further object of this invention to provide such a document exchange system which, although easier to use, less costly, and easier to implement than the prior art document exchange systems, still provides controlled access of the document exchange system to a selected group of people or companies.

It is a further object of this invention to provide such a document exchange system which is independent of content and format and thus more universal in design.

This invention results from the realization that a more efficient, less costly, easier to use, easier to implement and more universal document exchange system can be effected by creating a capsule which merges a document to be searched with access control information for that document, indexing each capsule, and searching the database of indexes to the retrieve the appropriate documents. Such a system is content neutral in that the documents available to be searched can be in any format which results in the advantage that any type of document can be posted including requests for proposals from a wide variety of industries. Additionally, search requests need not be formatted according to complex specifications. This allows entities such as companies and organizations without computer specialists to both post documents and to search for already posted documents in a secure manner.

The present invention concerns a document exchange system which includes a write dispatcher configured to receive a semi-structured document to be posted by a first party and configured to receive access control information from the first party relating to authorized reviewers of the document to be posted. This system also includes a capsule creator, responsive to the write dispatcher, configured to merge the semi-structured document and access control information into a capsule in the form of a second semi-structured document. The document portion of this second semi-structured document that is to be posted is annotated with a first annotation and the access control information portion is annotated with the second annotation. This document exchange system further includes a capsule database that stores the capsule, an indexer configured to create an index entry for the capsule, an index database that stores the index entry. A read dispatcher receives a query from a second party and is configured to receive identification information from the second party. A query creator is configured to create an annotated query in the form of the second party query annotated with the first annotation and the identification information annotated with the second annotation. A query processor searches the index database to find all index entries which match the annotated query and a storage server retrieves from the capsule database all capsules which correspond to matched index entries. A capsule extractor is configured to extract from all retrieved capsules the posted documents to be forwarded to the second party.

The present invention may also include a first party interface program which provides, to the first party, a selection of screens which prompt the first party to enter the documents to be posted in a semi-structured form and to enter the access control information. The system may also include a second party interface program which provides, to the second party, a selection of screens which prompts the second party to enter a query and which automatically retrieves identification information from the second party. The semi-structured document to be posted may be in XML form. The system may also include a database of authorized users and a security manager for confirming that each first and second party is an authorized user. The capsule creator of this system may be further configured to merge first party authorization information into the capsule with a third annotation associated with the authorization information. A database of accounting data and an account manager may be used for accessing the accounting database to keep track of postings by first parties and queries by second parties. A lease manager is responsive to any document posting expiration information from the first party and the capsule creator may be configured to merge expiration information into the capsule with a fourth annotation associated with expiration information. Typically, the query processor is a search engine.

This invention also includes a method for efficiently and securely exchanging documents between a first and second party. The method includes receiving a semi-structured document to be posted by a first party and access control information from the first party relating to the document. The method includes merging the semi-structured document and the access control information into a capsule in the form of second semi-structured document, and storing the capsule in a capsule database. A query is then received from a second party, along with identification information. The method also includes searching the capsule database to find all capsules which match the query and in which the identification information matches the access control information. For each capsule found, the document is extracted and provided to the second party.

### BRIEF DESCRIPTION OF THE DRAWINGS

Other objects, features and advantages will occur to those skilled in the art from the following description of a preferred embodiment and the accompanying drawings, in which:

FIG. 1 is a block diagram showing the primary components associated with a prior art document exchange system;

FIG. 2 is an overview block diagram showing the primary components and their relation to each other associated with the document exchange system of the subject invention;

FIG. 3 is an illustration of a shipment request search page screen presented to the second party in accordance with the present invention;

FIG. 4 is an illustration of a capsule, generated by the capsule creator in FIG. 2, in accordance with the subject invention;

FIG. 5 is an illustration of an index entry, generated by the capsule indexer in FIG. 2, in accordance with the subject invention;

FIG. 6 is an illustrative example of an annotated query, generated by the query creator in FIG. 2, in accordance with the subject invention;

FIG. 7 is an illustration of a form of the identification information received from the second party in accordance with the subject invention;

FIG. 8 is an illustration of access control information input by the first party and received by the HTTP dispatcher in FIG. 2 of the subject invention;

FIG. 9 is an illustration of a shipment request screen presented to the first party in accordance to the subject invention;

FIG. 10 is an illustration of a screen, generated by the second party interface program in FIG. 2, presented to the second party to post a quote by inputting the necessary information to generate a quote;

FIG. 11 is an illustration of a purchase order screen, generated by the first party interface program in FIG. 2, presented to first party to input the information necessary to create a purchase order signifying acceptance of a quote;

FIG. 12 is an illustration of a quote comparison chart screen, generated by the first party interface program in FIG. 2, presented to the first party to compare different quotes;

FIG. 13 is an illustration of a semi-structured document input by the first party and received by the HTTP dispatcher in FIG. 2 in accordance to the subject invention;

FIG. 14 is an illustration of a query input by the second party to view the posted information in accordance to the subject invention;

FIG. 15 is an illustration of a capsule, generated by the capsule creator in FIG. 2, containing a document, authorization information, access control information and expiration (lease) information marked accordingly.

### DISCLOSURE OF THE PREFERRED EMBODIMENT

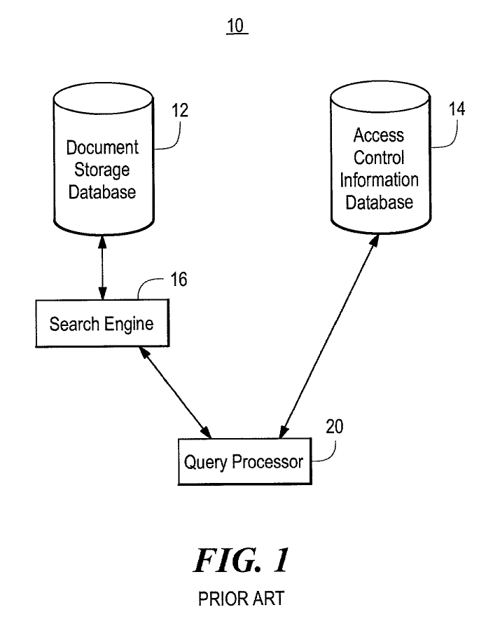

Prior art document exchange system 10, FIG. 1 includes document storage database 12, access control information database 14, search engine 16, and query processor 20. Following the example set forth in the background section above, an automobile manufacturer may post its requirements and/or the engineering specifications for batteries to document storage database 12 accessible via the Internet to various battery manufacturers. The automobile manufacturer, however, may want to limit access to document storage database 12 to only pre-approved, pre-qualified vendors. Accordingly, access control information generated and stored in access control information database 14. Search engine 16 in conjunction with query processor 20 receives all incoming search requests from suppliers. If a supplier is searching for battery specifications, query processor 20 assembles the search request into a query, notes the supplier's identity, and passes the query to search engine 16 which searches document storage database 12 for all documents which contain the word “battery”. Once all such documents are found, query processor 20 determines which found documents can be accessed by the supplier by searching access control information database 14 and passing on to the supplier only those documents which the supplier is entitled to view.

As stated in the background section above, such an architecture is complex in design and results in actually two searches. Moreover, when a textual search engine such as ALTAVISTA® is used, it searches every word of every document and would find many irrelevant documents and also relevant documents that include the word “battery”. Every document found, whether relevant or not, must be evaluated against the access control information.

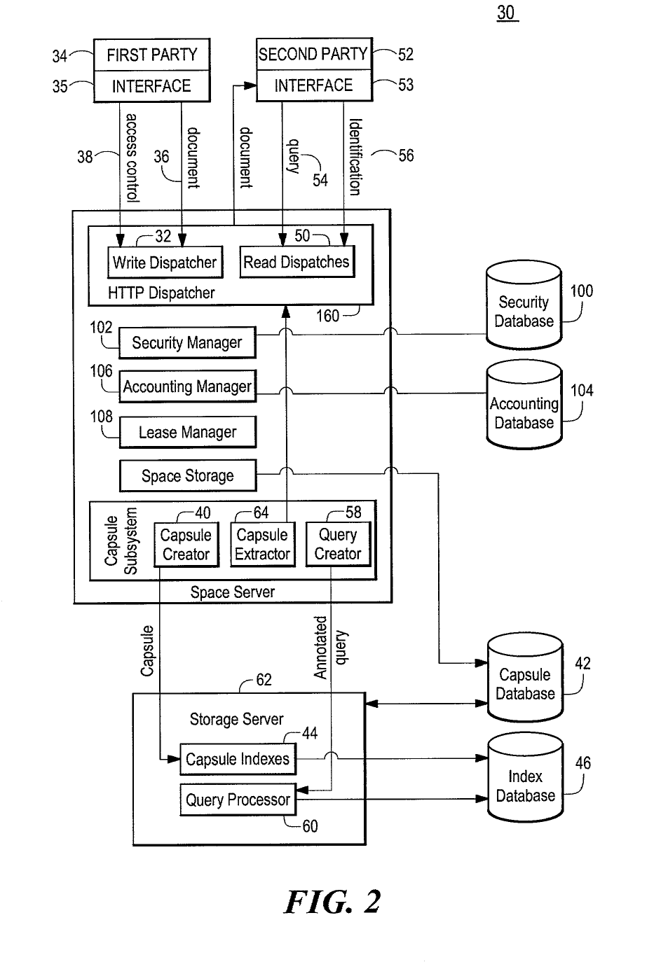

Document exchange system 30, FIG. 2 of this invention includes write dispatcher 32 configured to receive a semi-structured document in XML form via communication link 36 posted by first party interface program 35 and also configured to receive access control information via communication link 38 from first party interface program 35 relating to authorized reviewers of the document to be posted.

Document exchange system 30 further includes capsule creator 40 responsive to write dispatcher 32 configured to merge the semi-structured document and the access control information from link 38 into a capsule in the form of a second semi-structured document where the document to be posted is annotated with a first annotation and the access control information is annotated with a second annotation. Capsule database 42 stores this capsule, and capsule indexer 44 is configured to create an index entry for the capsule which is stored in index database 46. This way, if the first party is the motor vehicle manufacturer discussed above, the battery specifications and the list of vendors who are authorized to view those battery specifications are merged into a capsule by capsule creator 40 in the form of a semi-structured document, that capsule is stored in capsule database 42, and indexed by capsule indexer 44 resulting in an index stored in index database 46.

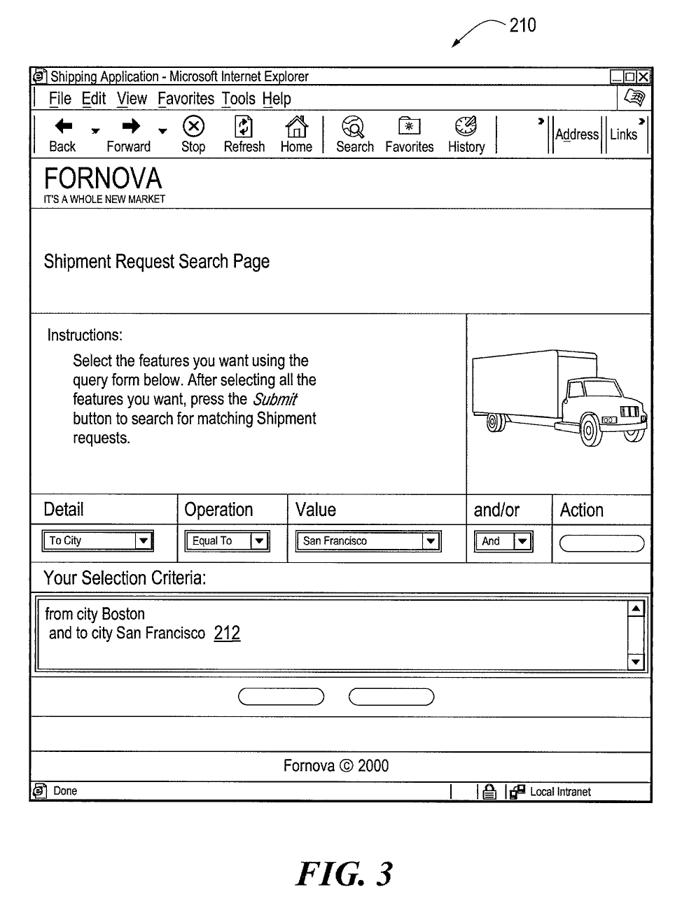

Read dispatcher 50 receives a query from second party interface program 53 via communication link 54 and also receives identification information from second party interface program 53 via communication link 56. To receive the query from second party 52, second party interface program 53 generates web page screen 210, FIG. 3. In this example, second party 52, who may be a company desiring to make a quote, can easily search the shipping requests by typing the searching criteria at 212. Query creator 58 FIG. 2 is configured to create an annotated query in the form of the second party query annotated with the first annotation and the identification information annotated with the second annotation. Query processor 60, which is typically a search engine such as ALTAVISTA®, searches index database 46 to find all index entries that match the annotated query and storage server 62 retrieves from capsule database 42 all capsules that correspond to the matched index entries.

Finally, capsule extractor 64 is configured to extract from all the retrieved capsules the original posted documents which are then forwarded to second party interface program 53.

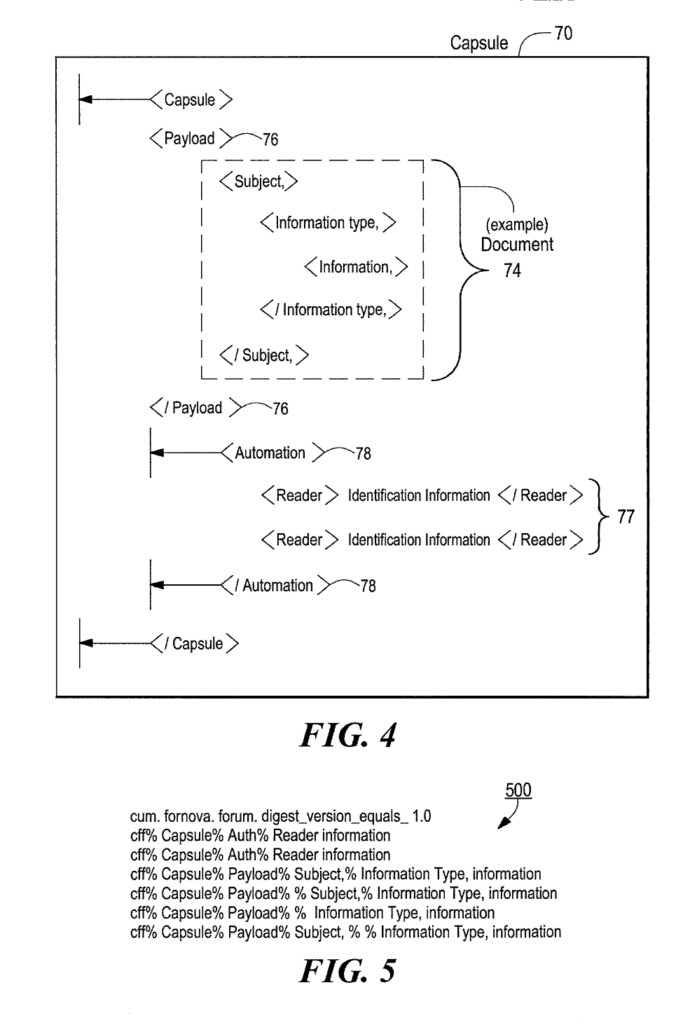

As stated above, by creating a capsule which merges a document to be searched with access control information for that document, then indexing each capsule, and then searching the database of indexes to retrieve the appropriate documents, document exchange system 30 is essentially content neutral and able to process and search for documents in any format whether they be battery specifications, requests for shipping quotes, or insurance coverage documents. FIG. 4 is an example of such a capsule that is created by capsule creator 40, FIG. 2, and stored in capsule database 42 wherein capsule 70, FIG. 4, includes the document to be posted 74 in the form of a second semi-structured document annotated with first annotation 76 (here “payload”). Capsule 70 further includes access control information 77 annotated with second annotation 78 (here “authorization”). Capsule 70 is then stored in capsule database 42, FIG. 2 as discussed above.

Indexer 44 then creates an index entry 500, FIG. 5 for the capsule and which is stored in index database 46, FIG. 2.

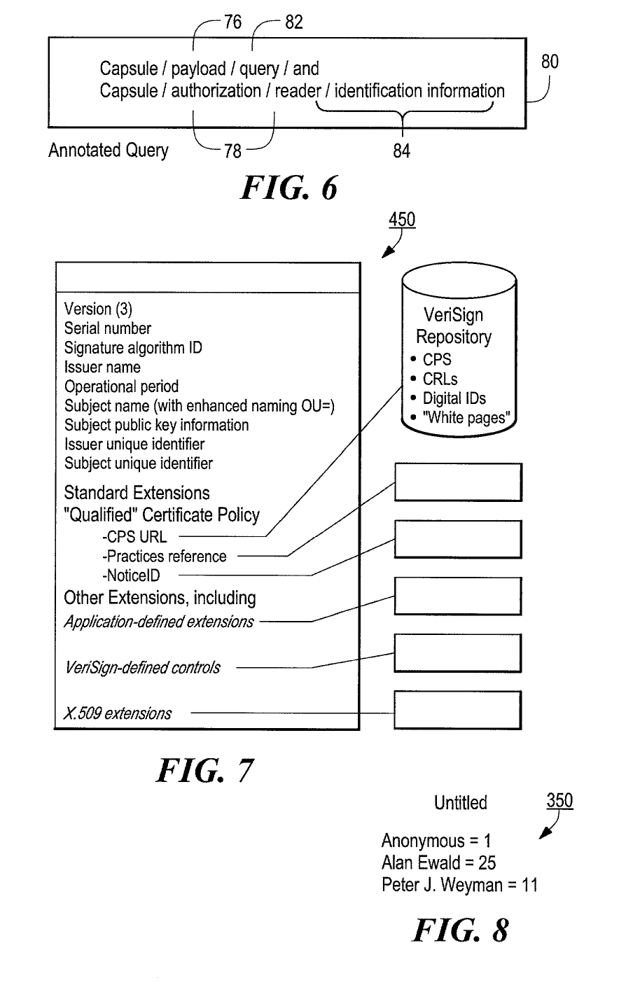

Read dispatcher 50 then receives a query and identification information from the battery supplier. Query creator 58, FIG. 2 creates an annotated query in the form shown in FIG. 6. Annotated query 80, FIG. 6 includes the battery supplier's query 82 annotated with first annotation 76 and identification information 84 annotated with second annotation 78. Query processor 60, FIG. 2 searches the index database 46 to find all index entries which match annotated query 80, FIG. 5 and storage server 62, FIG. 2 retrieves from capsule database 42 all capsules (such as capsule 70 shown in FIG. 4) which correspond to the matched index entries. Finally, capsule extractor 64, FIG. 2 extracts from all the retrieved capsules the original posted documents which are then forwarded to the battery supplier.

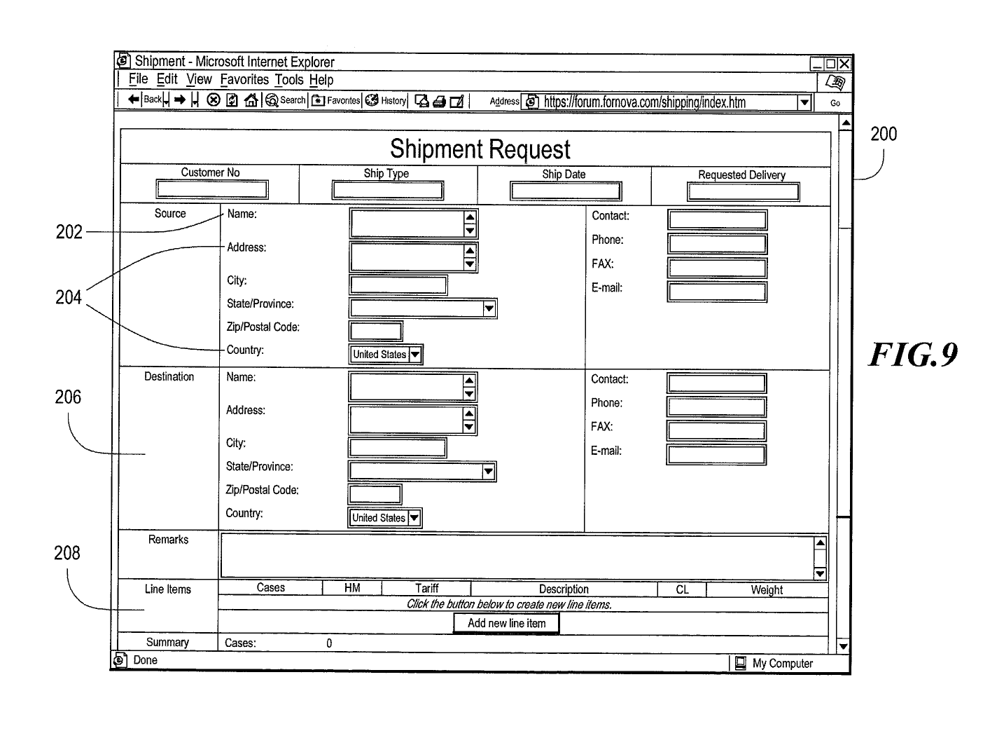

System 30, FIG. 2, may further include security database 100 which includes a list of authorized users of the system and security manager 102 for confirming that first party 34 and second party 52 are authorized users. Capsule creator 40 may provide a third annotation for each capsule associated with the authorization information stored in security database 100 to ensure that only authorized users of system 30 are able to post and retrieve documents. A by-product of the security manager's inspection of security database 100 is that identification information received from second party 56 that are in one form 450, FIG. 7 are changed to a second form 350, FIG. 8. System 30 in FIG. 2 may further include accounting database 104 which includes accounting data and account manager 106 which accesses accounting database 104 to keep track of postings by first and second parties for billing purposes. Lease manager 108 may be provided to excise expired postings and capsule creator 40 may further annotate each document to be posted with a fourth annotation containing the expiration information.

First party interface program 35, FIG. 2 generates the appropriate web page screens. In an example of shipping request web page screen 200 FIG. 9, the first party, for example, a company desiring a quote on shipping prices, can easily input the information necessary for the second party to ultimately generate a quote. As such, screen 200, FIG. 9 includes the name of the first party 202, their address 204 and information specific to the document to be posted, such as the shipping destination 206 and the items to be shipped 208.

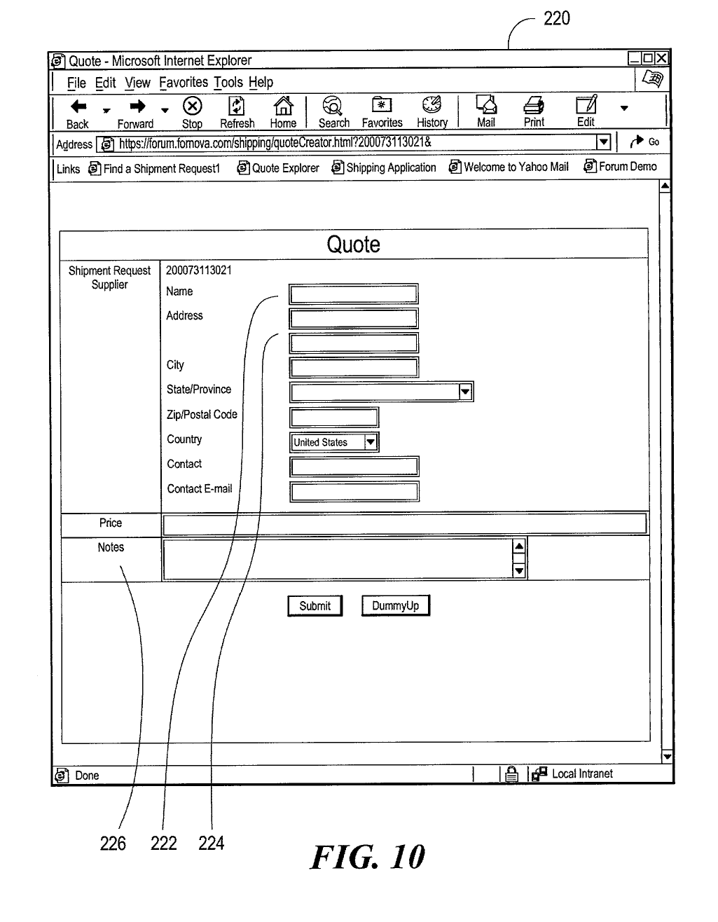

Second party interface program 53, FIG. 2 can generate web page screen 220, FIG. 10. In this web page screen, the second party, for example, a company desiring to make a quote, can easily input the information necessary to generate a quote. As such, screen 220, FIG. 10 includes the name of the second party 222, the address of the second party 224 and the information specific to the document to be posted, such as the price and notes 226.

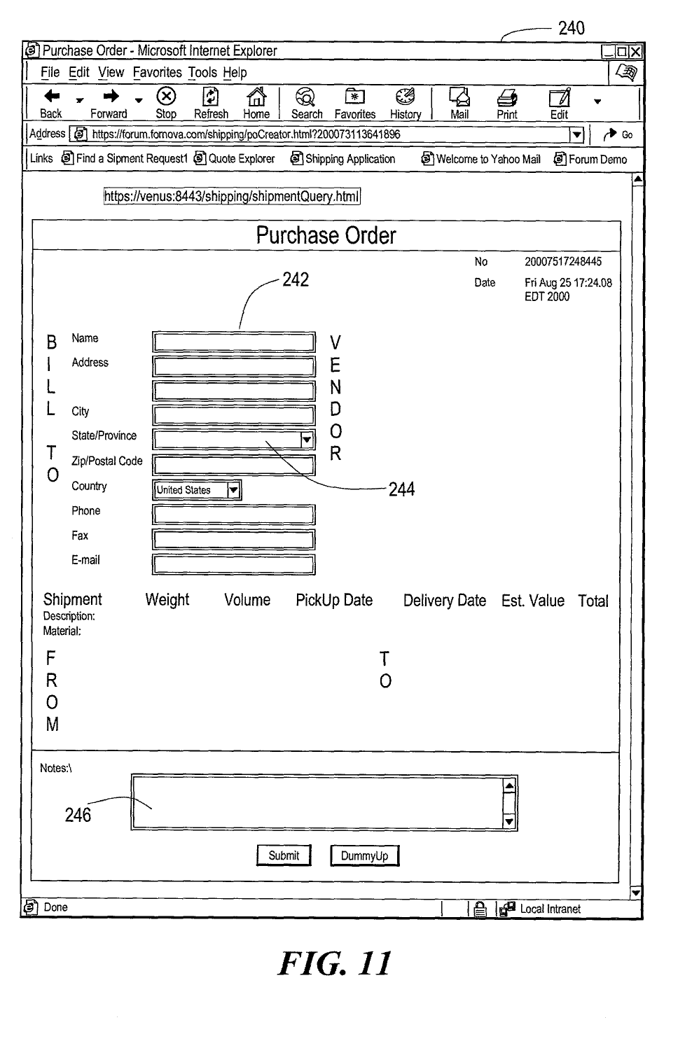

In addition, first party interface program 35, FIG. 2, can generate web page screen 240 FIG. 11. In this web page example, the first party, a company desiring a quote on shipping prices, can easily input the information necessary to create a purchase order signifying acceptance of a quote generated by the second party. As such screen 240, FIG. 11 includes the name of the first party 242, the first party's address 244, and information specific to the document to be posted, such as notes 246.

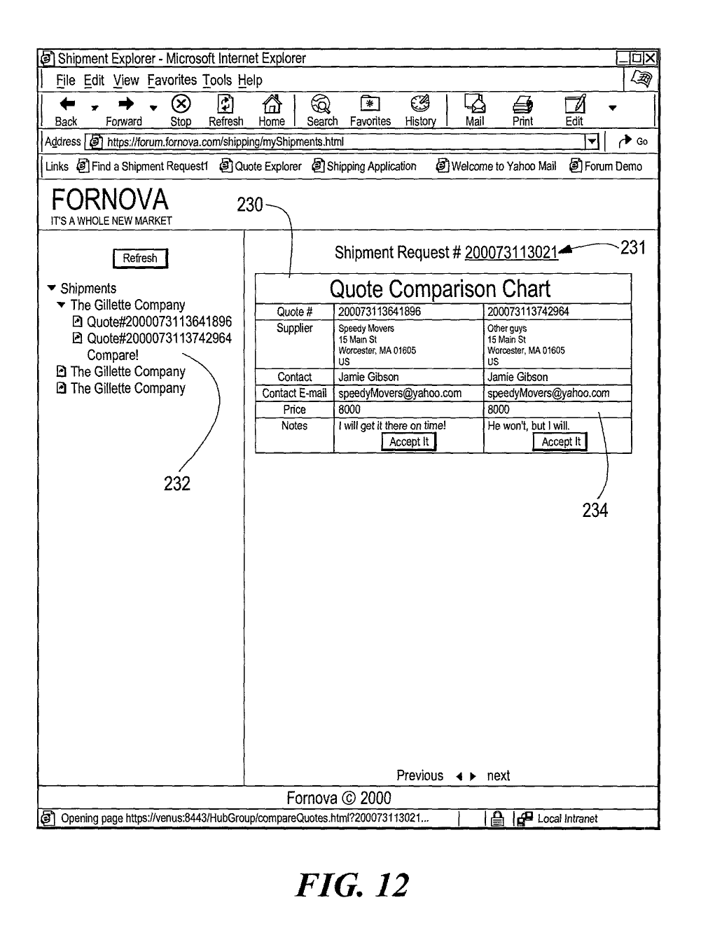

First party interface program 35, FIG. 2 can also generate quote comparison chart web page screen 230, FIG. 12. In this web page screen, the first party, for example a company desiring a quote on shipping prices, can easily view quotes generated by the second party. As such, screen 230, FIG. 12 displays the first party's requests for quote 231, the corresponding quotes generated by the second party 232, and the details of specific quotes 234.

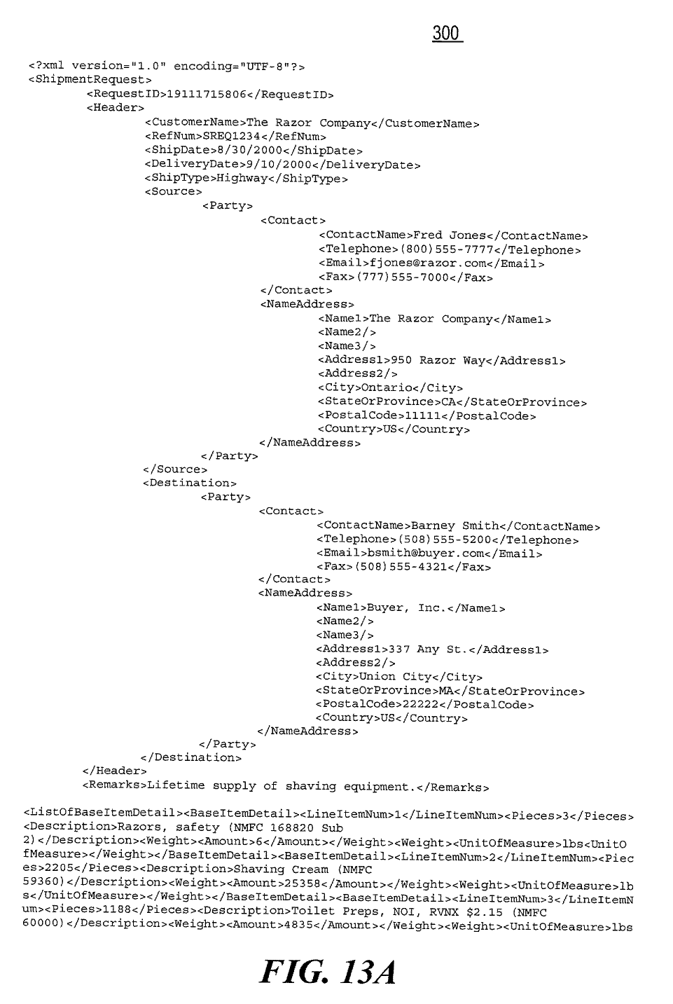

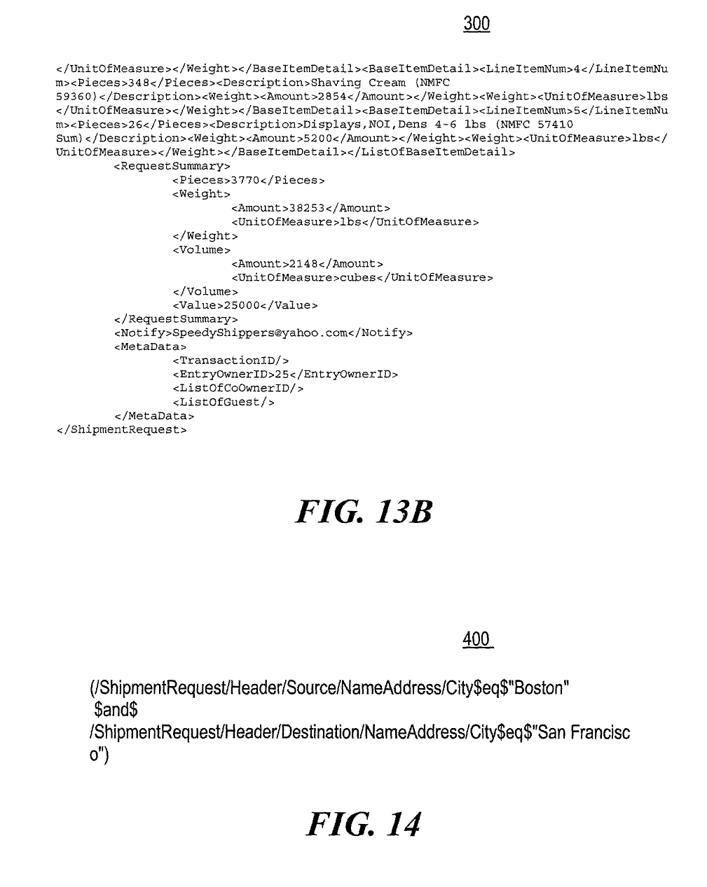

Suggested computer code responsible for first party 34 and second party 52 to connect to the system is attached hereto in appendix I. Once the parties are connected to the system, HTTP dispatcher 160, FIG. 2 receives the information input via the screens shown in FIGS. 6-10 and converts the document to be posted by the first party into a semi-structured document an example of which is shown at 300 in FIG. 13. HTTP dispatcher 160 also receives the access control information from the first party in the form 450, FIG. 7. Exemplary computer code for HTTP dispatcher 160, FIG. 2 is attached hereto in appendix II. Exemplary computer code for the write dispatcher 32, which is part of the HTTP dispatcher 160 and generates the semi-structured form of the document to be posted by the first party is also in appendix II.

Suggested computer code for capsule creator 40, FIG. 2 which receives the semi-structured document and access control information from write dispatcher 32, FIG. 2 is attached hereto as appendix III. Capsule creator 40 creates a second semi-structured document by merging the semi-structured document, an example of which is illustrated as 300 in FIG. 13, and the access control information, an example of which is illustrated as 350 in FIG. 8. One example of the code for the capsule created by the capsule creator 40, FIG. 2, is attached hereto as appendix IV. This capsule is then received by the capsule indexer 44, FIG. 2 having computer code attached hereto as Appendix V, which creates an index entry for the capsule. An example of an output generated by the capsule indexer 44 is attached hereto as appendix VI. This output is then input into the index database 46, FIG. 2. The second party 52 may view the posted information by making an inquiry input, an example of which is illustrated as 400 in FIG. 14. In order to identify this second party 52, FIG. 2, an interface program 53 extracts identification information from the second party's computer. The interface program may be in the form of the computer code and the identification information is in form 450, FIG. 7. The identification information shown in FIG. 7 is in an industry standard format called an X.509 digital certificate. Exemplary computer code for read dispatcher 50, FIG. 2 which is part of the HTTP dispatcher 160 and receives the inquiry and identification information from the second party is a part of appendix II.

The computer code for the query creator 58, FIG. 2 which creates an annotated query is attached hereto as appendix VII. Once the annotated query has been generated by the query creator 58, the query processor 60, FIG. 2 searches the index database 46 which contains the index entries for the capsule to find all index entries which match the annotated inquiry. The computer code for the storage server 62, FIG. 2 which retrieves from capsule database 42 all capsules that correspond to the matched index entries, is attached hereto appendix VIII. Capsule extractor 64, FIG. 2 extracts from the retrieved capsules, the posted documents requested by the second party. The code for this capsule extractor with those portions which strip everything but the posted documents to be sent to the second party is attached hereto as appendix IX. The HTTP dispatcher 160, FIG. 2 sends the posted documents extracted by the capsule extractor 64 to the second party. The code for the HTTP dispatcher which sends the posted documents to the second party is attached hereto as appendix X.

The computer code for security manager 102, FIG. 2 which confirms that the first party and the second party are authorized users, is attached hereto as appendix XI. The computer code responsible to manage the accounts for accessing the accounting database, to keep track of the posting by the first party 34, FIG. 2 and inquiries by the second party 52, is attached hereto as appendix XII.

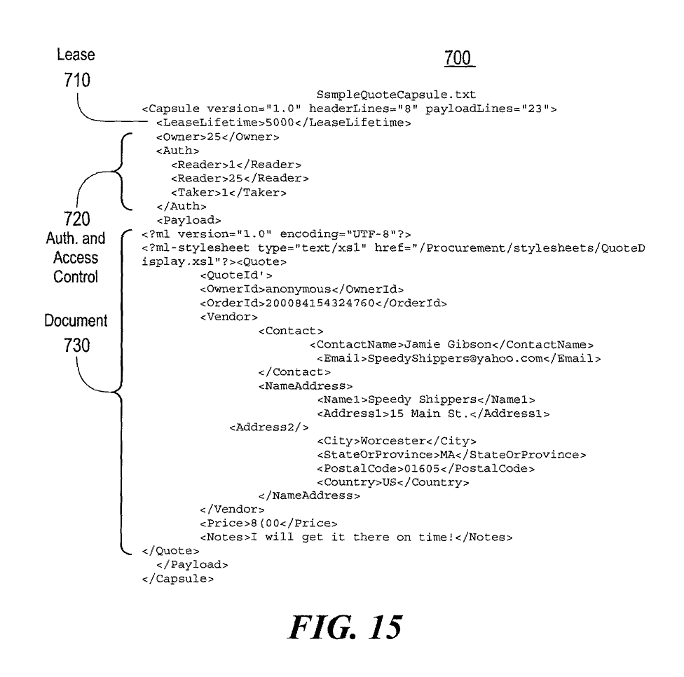

Lease manager 108, FIG. 2 of the document exchange system manages any document postings by the first party, by excising expired postings to better serve the first and the second party. Capsule creator 40 also merges expiration information from the lease manager 108 into the capsule with a fourth annotation that is associated with expiration information. One version of computer code for the lease manager 108 which keeps track of the expiration information and sends such information to the capsule creator 40, is attached hereto as appendix XIII. As illustrated in FIG. 15, a capsule may contain a computer code for documents 730, authorization information 720, access control information 720, and expiration (lease) information 710.

In one embodiment of the present invention, write dispatcher 32, FIG. 2 of HTTP dispatcher 160, receives a semi-structured document and access control information 38 from first party interface program 35. Capsule creator 40 (see appendix III), merges the semi-structured document and the access control information from HTTP dispatcher 160 into a second semi-structured document. This information is then stored in capsule database 42. Read dispatcher 50 then receives an inquiry 54 and identification information 56 from second party interface program 53. Capsule database 42 is then searched in accordance to the second party's inquiry to find all matched capsules in which the identification information matched the access control information. The documents are extracted from the matched capsules by capsule extractor 64 and are sent to the second party 52.

Capsule creator 40 is configured to merge the semi-structured document to be posted 76, FIG. 4, with the access control information for that document 78, FIG. 4, into a capsule in the form of a second semi-structured document. Query processor 60 then searches all capsules in response to the query and the capsule extractor 64 extracts the related posted documents.

The query creator 58 of the present invention combines the query and identification information into a single annotated query in which the query is annotated with first annotation 76, FIG. 6 and identification information is annotated with second annotation 78, FIG. 6.

The present document exchange system creates a capsule which merges a document to be searched with access control information for that document, indexing each capsule and searching the database of indexes to then retrieve the appropriate documents. This system can search different formatted documents and allows entities without computer specialists to both post documents and to search for already posted documents in a secure manner. This system results in a more efficient, less costly, easier to use, easier to implement and a more universal document exchange system.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

Other embodiments will occur to those skilled in the art and are within the following claims:

What is claimed is:

1. A document exchange system comprising:
a write dispatcher configured to receive a semi-structured document to be posted by a first party and configured to receive access control information from the first party relating to authorized reviewers of the document to be posted;
a capsule creator, responsive to the write dispatcher, configured to merge the semi-structured document and the access control information into a capsule in the form of a second semi-structured document with the document to be posted annotated with a first annotation and the access control information annotated with a second annotation;
a capsule database for storing the capsule;
an indexer configured to create an index entry for the capsule;
an index database for storing the index entry;
a read dispatcher for receiving a query from a second party and configured to receive identification information from the second party;
a query creator configured to create an annotated query in the form of the second party query annotated with the first annotation and the identification information annotated with the second annotation;
a query processor for searching the index database to find all index entries which match the annotated query;
a storage server for retrieving from the capsule database all capsules which correspond to matched index entries; and
a capsule extractor configured to extract from all retrieved capsules the posted documents to be forwarded to the second party.

2. The system of claim 1 further including a first party interface program which provides, to the first party, a selection of screens which prompt the first party to enter the documents to be posted in a semi-structured form and to enter the access control information.

3. The system of claim 1 further including a second party interface program which provides, to the second party, a selection of screens which prompt the second party to enter a query and which automatically retrieves identification information from the second party.

4. The system of claim 1 in which the semi-structured document to be posted is in XML form.

5. The system of claim 1 further including a database of authorized users and a security manager for confirming that each first and second party is an authorized user.

6. The system of claim 1 in which the capsule creator is further configured to merge first party authorization information into the capsule with a third annotation associated with the authorization information.

7. The system of claim 1 further including a database of accounting data and an account manager for accessing the accounting database to keep track of postings by first parties and queries by second parties.

8. The system of claim 1 further including a lease manager responsive to any document posting expiration information from the first party and wherein the capsule creator is further configured to merge expiration information into the capsule with a fourth annotation associated with expiration information.

9. The system of claim 1 in which the query processor is a search engine.

10. A method to efficiently and securely exchange documents between a first and a second party, the method comprising:
receiving a semi-structured document to be posted by a first party and access control information from the first party relating to the document;
merging the semi-structured document and the access control information into a capsule in the form of second semi-structured document;
storing the capsule in a capsule database;
receiving, from a second party, a query and identification information;
searching the capsule database to find all capsules which match the query and in which the identification information matches the access control information;
for each capsule found, extracting therefrom the document; and
providing all such documents found to the second party.

11. A document exchange system comprising:
a capsule creator configured to merge a semi-structured document to be posted and access control information for that document into a capsule in the form of a second semi-structured document;
a query processor for searching all capsules in response to a query with identification information; and
a capsule extractor configured to extract from any retrieved capsule the posted document.

12. The system of claim 11 in which the capsule creator is further configured to annotate the capsule such that the posted document has a first annotation and the access control information has a second annotation.

13. The system of claim 12 further including a query creator configured to combine the query and identification information into a single annotated query wherein each query is annotated with the first annotation and the identification information is annotated with the second annotation.
